(19) United States
(12) Patent Application Publication
(10) Pub. No.: US 2010/0020331 A1
(43) Pub. Date: Jan. 28, 2010

(54) Laser interferometer systems and methods with suppressed error and pattern generators having the same

(75) Inventor: Anders Svensson, Stockholm (SE)

Correspondence Address: HARNESS, DICKEY & PIERCE, P.L.C., P.O. BOX 8910, RESTON, VA, 20195, US

(73) Assignee: MICRONIC LASER SYSTEMS AB

(21) Appl. No.: 12/219,662

(22) Filed: Jul. 25, 2008

(51) Int. Cl. G01B 11/00

(52) U.S. Cl. 356/500

(57) ABSTRACT

An interferometer system for tracking a position of a movable object in a pattern generator is provided. The interferometer system includes an interferometer configured to generate an interference signal indicative of at least one instantaneous position of an object, and a control system. The control system generates raw position data based on the generated interference signal, selects a subset of position data from the raw position data, and extrapolates at least a third position of the object based on the selected subset of position data.

### BACKGROUND

During production of a photomask (e.g., a photo-reticle) or during direct patterning of a substrate, wafer or the like, a pattern generator creates a desired pattern on a workpiece.

Conventional pattern generators periodically expose a photomask to one or more optical beam(s), particle beam(s) or illumination (exposure) fields in a systematic manner. As is well-known, a conventional pattern generator, which periodically exposes a workpiece to exposure fields in a systematic manner, is referred to herein as an exposure field type system. As is also well-known, a conventional pattern generator that exposes the photomask to one or more optical or particle beams is referred to herein as a scanning pattern generator.

In the above-described systems, coordinate stages are used to position masks and move wafers to desired positions. Coordinate stages are also included in placement inspection tools in mask metrology.

Conventionally, the position and movement of a stage is monitored by a laser-interferometer. Accurate position and movement measurements by the laser-interferometer is necessary to ensure accurate alignment and/or patterning of a workpiece in, for example, pattern generators (e.g., electron beam and laser pattern generators). For similar reasons, accurate position and movement measurements are also necessary in metrology tools (e.g., optical and electron beam metrology tools).

However, conventional interferometer systems suffer from periodic errors, which are repeated within one half wavelength (λ/2) of the interferometer laser. These periodic errors result from, for example, polarization leakage between a measurement path and reference path. For example, imperfections in the polarizing beam splitter, quarter-wave plates and/or reflecting surfaces may disturb the polarization, which may result in a portion of the light intended for the measurement path ending up in the reference path, and vice versa. This leakage may distort the amplitude signal from the interferometer, which may affect subsequent signal analysis in the receiver.

These periodic errors affect the accuracy of the positioning and may deteriorate the performance of a system that depends on the interferometer data. As critical photolithographic linewidth feature sizes continue to decrease, the effects of these periodic errors increase.

### SUMMARY

Example embodiments provide laser interferometer systems and methods with suppressed error and pattern generators having the same.

At least one example embodiment provides an interferometer system for tracking a position of a movable object in a tool including a coordinate stage. The tool may be one of a pattern generator, a metrology tool, and an inspection tool. According to at least this example embodiment, an interferometer may be configured to generate an interference signal indicative of at least one instantaneous position of an object. A control system may be configured to generate raw position data based on the generated interference signal, and extrapolate at least a third position of the object based on the raw position data. The raw position data may represent a first and second position of the object.

At least one other example embodiment provides a tool including a coordinate stage. The tool may be one of a pattern generator, a metrology tool, and an inspection tool. The tool may include an interferometer system and an exposure system for exposing the workpiece according to the tracked position of the object. The interferometer system may include an interferometer configured to generate an interference signal indicative of at least one instantaneous position of an object. A control system may be configured to generate raw position data based on the generated interference signal, and extrapolate at least a third position of the object based on the raw position data. The raw position data may represent a first and second position of the object. The object may be a stage on which a workpiece is arranged.

At least one other example embodiment provides a method for tracking a position of a movable object in a tool having a coordinate stage. The method may include: generating an interference signal indicative of at least one instantaneous position of an object; generating raw position data based on the generated interference signal; and extrapolating at least a third position of the object based on the raw position data. The raw position data may represent a first and second position of the object. The tool may be one of a pattern generator, a metrology tool, and an inspection tool.

At least one other example embodiment provides a method for exposing a workpiece. According to at least this example embodiment, a position of an object may be tracked, and the workpiece may be exposed according to the tracked position of the object. The position of the object may be tracked by: generating an interference signal indicative of at least one instantaneous position of an object; generating raw position data based on the generated interference signal; and extrapolating at least a third position of the object based on the raw position data. The raw position data may represent a first and second position of the object.

According to at least some example embodiments, the control system may be further configured to select a subset of position data from the raw position data. The subset of position data may include at least two data points. The control system may extrapolate at least the third position of the object based on the selected subset of position data. At least two data points may be at least a distance of λ/2 from one another, where λ represents a wavelength of a laser used to generate the interference signal.

According to at least some example embodiments, the subset of position data may be selected such that each data point in the subset has a same or substantially the same associated error. To generate at least the third position, the control system may be further configured to calculate a velocity of the object based on the selected subset of position data. At least the third position may be extrapolated based on the at least two positions in the subset and the calculated velocity.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a pattern generator according to an example embodiment;

FIG. 2 illustrates an interferometer system according to an example embodiment; and

FIG. 3 illustrates a method for predicting positions of an object according to an example embodiment.

### DETAILED DESCRIPTION OF EXAMPLE EMBODIMENTS

In the following description, for purposes of explanation and not limitation, specific details are set forth such as particular architectures, interfaces, techniques, etc., in order to provide a thorough understanding of the present invention. However, it will be apparent to those skilled in the art that the present invention may be practiced in other illustrative embodiments that depart from these specific details. In some instances, detailed descriptions of well-known devices, circuits, and methods are omitted so as not to obscure the description of the present invention with unnecessary detail. All principles, aspects, and embodiments of the present invention, as well as specific examples thereof, are intended to encompass both structural and functional equivalents thereof. Additionally, it is intended that such equivalents include both currently known equivalents as well as equivalents developed in the future.

In the following description, at least some example embodiments will be described with reference to acts and symbolic representations of operations (e.g., in the form of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

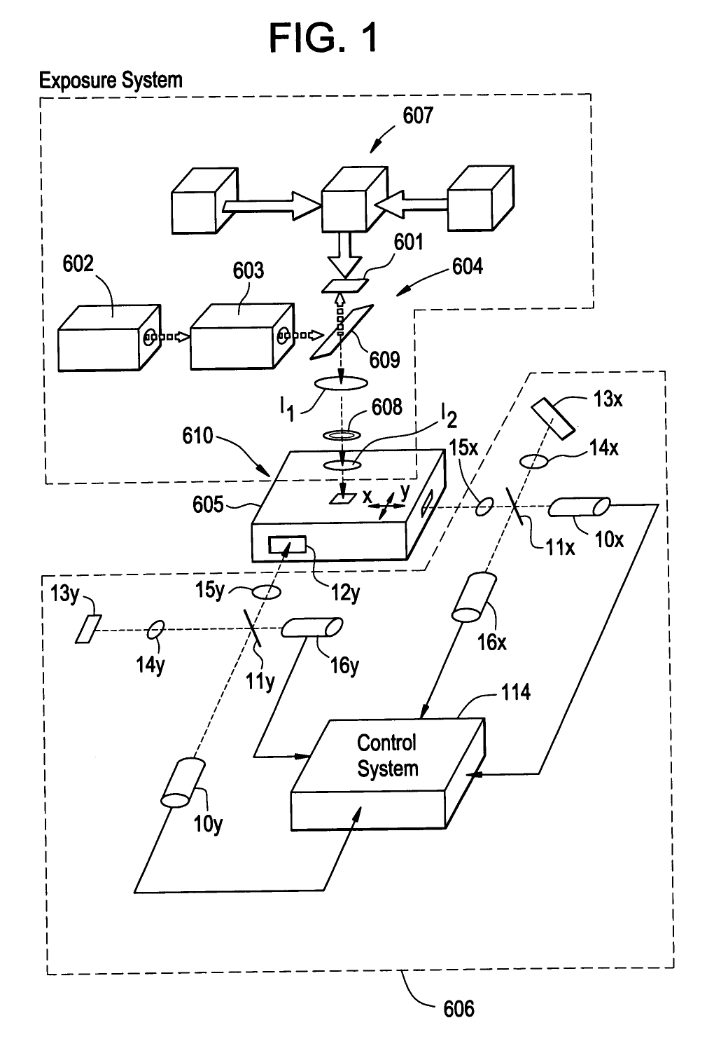

Although not required, example embodiments may be implemented in the general context of computer-executable instructions, such as program modules or functional processes, being executed by one or more computer processors or CPUs. Generally, program modules or functional processes include routines, programs, objects, components, data structures, etc. that performs particular tasks or implement particular abstract data types. The program modules and functional processes discussed herein may be implemented using existing hardware in existing pattern generators, metrology systems or the like. For example, although example embodiments will be described with regard to the exposure field-type system shown in FIG. 1, it will be understood that example embodiments may be implemented in connection with a scanning pattern generator.

FIG. 1 illustrates a pattern generator according to an example embodiment. The pattern generator shown in FIG. 1 is an exposure filed-type system that exposes a photomask to one or more optical or particle beams.

Referring to FIG. 1, the pattern generator may illuminate a substrate, wafer or workpiece using electromagnetic radiation emitted by a laser source 602. For example, the laser source 602 may emit a krypton fluoride (KrF) excimer laser beam providing a light flash having a duration of about 10-20 nanoseconds in the ultra-violet (UV) region at about 248 nanometer wavelength with a bandwidth corresponding to the natural linewidth of an excimer laser.

To suppress pattern distortion on the substrate, the light from the laser source 602 may pass through a beam scrambling device 603 and may be distributed (e.g., uniformly distributed) over the surface of the spatial light modulator (SLM) 601. The light may have a coherence length short enough to suppress production of laser speckle on the substrate.

The light from the SLM 601 is relayed toward an optical system 604 and imaged down to the substrate on a fine positioning substrate stage 610. The fine positioning substrate stage 610 may include a moveable air bearing x-y table 605.

The optical system 604 may include a lens l₁ with a focal width f₁. The lens l₁ may be positioned at a distance f₁ from the SLM 601. The optical system 604 may also include a lens l₂ with a focal length f₂. The lens l₂ may be placed at a distance 2*f₁+f₂ from the SLM 601. Accordingly, the substrate may be positioned at a distance (2*f₁+2*f₂) from the SLM 601. An aperture 608 may be positioned at a distance 2*f₁ from the SLM 601. The size of the aperture 608 determines the numerical aperture (NA) of the system, and thereby the minimum pattern feature size that may be written on the substrate.

To correct for imperfections in the optical system 604 and the substrate flatness, the pattern generator may include a focal system that dynamically positions the lens l₂ in the z-direction with a position span of about 50 micrometers to achieve optimal focal properties. The lens system is also wavelength corrected for the illuminating wavelength of about 248 nanometers and has a bandwidth tolerance of the illuminating light of at least ± about 1 nanometer. The illuminating light is reflected into the imaging optical system using a beamsplitter 609 positioned immediately above the lens l₁. For a demagnification factor of about 250 and a numerical aperture (NA) of about 0.62, pattern features having a size down to about 0.2 micrometers with may be exposed with sufficient pattern quality.

The pattern generator may further include a hardware and software data handling system 607 for the SLM 601 and an interferometer position control system 606. Data handling systems are well-known in the art, and thus, a detailed discussion will be omitted.

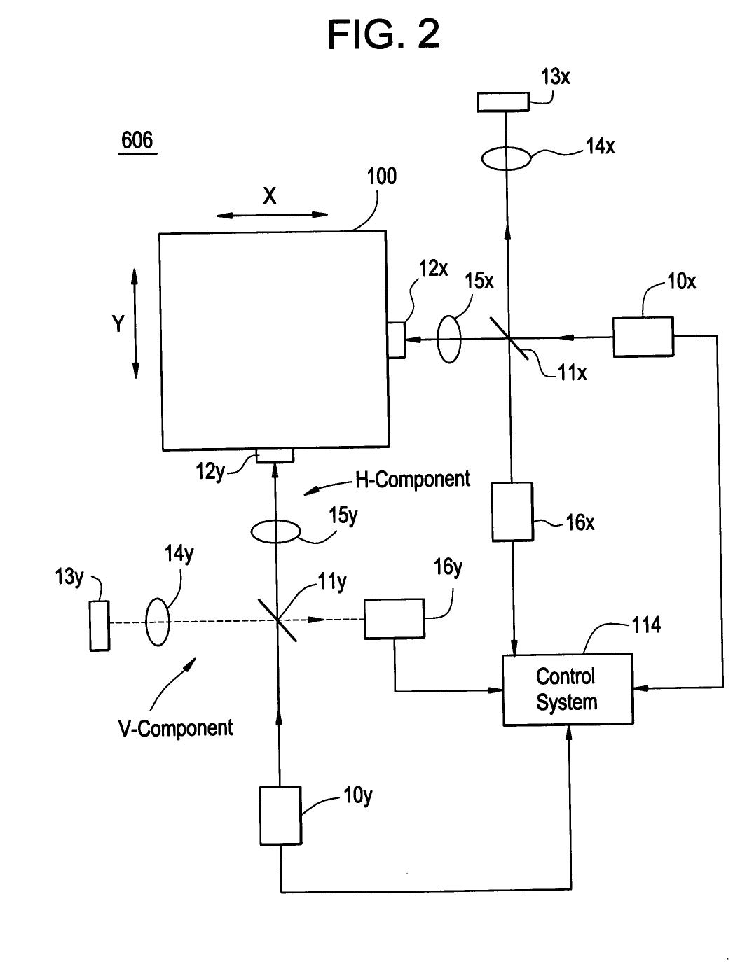

The interferometer position control system 606 and a servo system (not shown) may control the positioning of the stage 610 in the x and y directions. The interferometer position control system 606 corresponds to the interferometer system shown in FIG. 2, which will be described in more detail below.

The stage 610 may move in both the x and y directions and the interferometer position control system 606 may be used to control positioning of the stage 610, trigger exposure laser flashes to provide more uniform position between each image of the SLM 601 on the substrate, etc.

In one example, the pattern generator may expose a full row of SLM images on the substrate, move back to the original position in the x direction, move one SLM image increment in the y direction, and expose another row of SLM images on the substrate. This procedure may be repeated until the entire substrate is exposed.

FIG. 2 is a top-view of an example embodiment of the interferometer position control system shown 606 shown in FIG. 1. The interferometer position control system 606 may be used to measure a relative position of an object 100, which may then be used by the pattern generator to, for example, trigger exposure laser flashes.

The interferometer position control system 606 may include a separate interferometer system for measuring a position of the object 100 (e.g., a stage of a pattern generator in the example above) in the x-direction (referred to as the x-direction interferometer system) and in the y-direction (referred to as the y-direction interferometer system).

The y-direction interferometer system will now be described with reference to FIG. 2. In FIG. 2, corresponding components of the y-direction interferometer and the x-direction interferometer will be distinguished from each other by being designated with identical symbols suffixed with an ‘x’ or a ‘y’ to denote their inclusion in the x-direction or y-direction interferometer system. Because corresponding components of the x-direction interferometer system and the y-direction interferometer system may have a similar or substantially similar configuration and functionality, a detailed description of the x-direction interferometer system will be omitted for the sake of brevity.

The y-direction interferometer system may include a y-direction laser interferometer (or y-interferometer) for measuring the position of the object 100 in the y-axis direction. The y-interferometer may be, for example, a Michelson-Morley (or Michelson) heterodyne laser interferometer. However, other interferometers may be used.

Referring still to FIG. 2, the y-interferometer includes a laser head 10Y, a polarizing beam splitter 11Y, a moving mirror 12Y, a fixed mirror 13Y, quarter-wave plates (hereinafter referred to as “λ/4 plates”) 14Y and 15Y and a receiver 16Y.

The receiver 16Y houses a photoelectric conversion element and a polarizing element (not shown), with the polarizing element being set such that the angle of polarization is 45 degrees in relation to the p-polarized light and s-polarized light (e.g., also referred to as H-component and V-component, respectively).

The laser head 10Y may include a light source and a detector unit (not shown). The light source may emit a two-frequency laser based on the Zeeman effect. In this light source, the frequency is stabilized and the Zeeman effect is used to obtain an oscillation frequency (and thus a wavelength) that varies by about 2-3 MHz. The output may be a laser light flux composed of normally distributed circular beams containing a first polarized component and a second polarized component with mutually orthogonal polarization directions.

The first polarized light component is a polarized light component (also referred to as “p-polarized light”) parallel to a light incidence plane with respect to the light separation plane of the polarizing beam splitter 11Y, for example, parallel to a plane containing the light incident on the light separation plane and normal to the light separation plane. This component is referred to herein below as “the H-component.” The second polarized light component is a polarized light component (also referred to as “s-polarized light”) perpendicular to the light incidence plane with respect to the light separation plane of the polarizing beam splitter 11Y. This component is referred to herein below as “the V-component.”

The detector unit of the laser head 10 monitors the phase change resulting from the interference between the two oscillation wavelengths output by the light source (e.g., between the V-component and the H-component) and sends the monitoring signal as a reference signal for the detection of the phase difference to the control system 114.

The polarizing beam splitter 11Y is an optical element for passing a prescribed polarized light component and reflecting the polarized light component orthogonal thereto. In this example, the H-component and the V-component are separated as a result of the fact that the H-component from the laser head 10Y is transmitted unchanged, whereas the V-component is reflected.

The moving mirror 12Y is a mirror fixed to the end face of the object 100 on a side facing the y-interferometer. The moving mirror 12Y moves together with the object 100. The fixed mirror 13Y is fixed at a prescribed position (e.g., to the pattern generator in which the interferometer system may be implemented).

The operation of each component of the y-interferometer will now be described.

Referring to FIG. 2, laser light emitted by the laser head 10Y is directed toward the polarizing beam splitter 11Y. The beam splitter 11Y separates the incident laser light into an H-component (also referred to as p-polarized light or measurement beam) and a V-component (also referred to as s-polarized light or reference beam).

The reference beam (V-component) reflected by the beam splitter 11Y is transmitted by the λ/4 plate 14Y, converted to circularly polarized light, reflected by the fixed mirror 13Y, and retransmitted by the λ/4 plate 14Y in a reverse direction relative to the initial direction. Each time the reference beam passes through the λ/4 plate 14Y, the reference beam is rotated 45 degrees relative to the propagation axis of the light. Thus, prior to first passing through the λ/4 plate 14Y, the reference beam is p-polarized light, whereas after passing through the λ/4 plate 14Y a second time, the reference beam is s-polarized light.

After being reflected and passing through the λ/4 plate 14Y, the reference beam is transmitted by the polarizing beam splitter 11Y and directed toward the receiver 16Y.

The measurement beam (H-component) transmitted by the beam splitter 11Y is converted to circularly polarized light by the λ/4 plate 15Y, reflected by the moving mirror 12Y, and retransmitted by the λ/4 plate 15Y in a reverse direction relative to the initial direction. Each time the measurement beam passes through the λ/4 plate 15Y, the measurement beam is rotated 45 degrees relative to the propagation axis of the light. Thus, prior to first passing through the λ/4 plate 15Y, the measurement beam is s-polarized light, whereas after passing through the λ/4 plate 15Y a second time, the measurement beam is p-polarized light.

After being reflected and passing through the λ/4 plate 15Y, the measurement beam is directed (or reflected) toward the receiver 16Y by the polarizing beam splitter 11Y.

As discussed above, the receiver 16Y houses a photoelectric conversion element and a polarizing element (not shown), with the polarizing element being set such that the angle of polarization is 45 degrees in relation to the V-component and H-component (e.g., the measurement beam and reference beam) from the polarizing beam splitter 11Y. The 45 degree angle of polarization of the polarizing element in the receiver 16Y is used such that V-component and H-component light interfere with one another.

The vector constituent of the V-component transmitted by the polarizing beam splitter 11Y (referred to as polarized light VV) and the vector constituent of the H-component reflected by the polarizing beam splitter 11Y (referred to as polarized light VH) strikes the photoelectric conversion element in the receiver 16Y. The photoelectric conversion element photo-electrically converts the polarized light of the two vector constituents and feeds the resulting electric signal (interference signal) to a control system 114. The control system 114 may be in the form of a computer including one or more digital signal processors (DSPs), application-specific-integrated-circuits, field programmable gate arrays (FPGAs) computers or the like.

The control system 114 receives a reference signal for phase detection from the laser head 10Y in the manner described above, performs calculations using this reference signal, and determines the y-position (displacement of the object 100 in the y-axis direction) of the moving mirror 12Y with relatively high accuracy. The control system 114 processes signals according to a well-known method pertaining to, for example, heterodyne interferometers, to generate raw position data for the object 100. Accordingly, the specifics of such processing will be omitted.

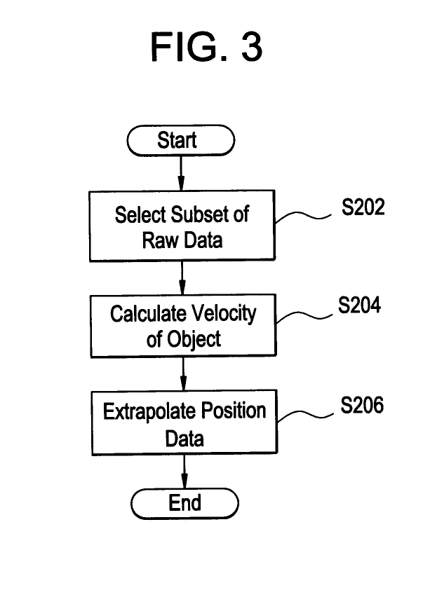

The control system 114 may predict subsequent positions of the object 100 based on the acquired raw position data. A method for predicting subsequent positions of the object according to example embodiments is shown in FIG. 3. The method shown in FIG. 3 will be described assuming that the control system 114 has generated raw position data including positions y₀, y₁, y₂, . . . yₙ, at times t₀, t₁, t₂, . . . , tₙ, respectively. In this example, y₀ and t₀ are a reference y-position and a reference time, respectively. The raw position data {y₀, y₁, y₂, . . . yₙ} and associated times {t₀, t₁, t₂, . . . , tₙ} may be stored in a memory at the control system 114.

According to example embodiments, the sampling frequency of the interferometer position control system 606 used to generate the position data should be sufficiently high such that at least one datum is measured in the vicinity of a desired position in the subset data. In one example, the sampling frequency of the interferometer 606 may be about 10 MHz.

Referring to FIG. 2, at S202 the control system 114 may select a subset of positions from the raw position data to be used in predicting the subsequent position of the object 100. The subset of positions may be selected such that each position in the subset of positions are about

$${N}_{M} \frac{λ}{2}$$

distance apart from one another, where λ is the wavelength of the laser emitted by the laser head 10Y and N_{M} is any integer. In one example, if the laser emitted from the laser head 10Y has λ=632 nm, and the subset of positions S includes two positions ys₁ and ys₂, then the subset S is selected such that ys₂−ys₁=N_{M}*316 nm.

The accuracy of the predicted data may depend on the extrapolation algorithm and the residual error from the selected sub-set data, but may reduce or eliminate the periodic effect of the measurement error from the interferometer.

Returning to FIG. 2, in one example, (although example embodiments are not limited to this example) the control system 114 may select a reference position ysR having a relatively low error (e.g., minimum error) to generate the subset. The subset of y-positions S may then be generated based on the reference position. For example, the subset S may include positions

$$\{ \begin{matrix}ysR , ( ysR + {N}_{1} \frac{λ}{2} ) , ( ysR + {N}_{2} \frac{λ}{2} ) , \\ ( ysR + {N}_{3} \frac{λ}{2} ) , … ( ysR + {N}_{M} \frac{λ}{2} )\end{matrix} \} ,$$

where {N₁, N₂, N₃, . . . N_{M}}is a set of integers in which N₁<N₂<N₃<, . . . , <N_{M}. The corresponding subset of times may be {ts₀, ts₁, ts₂, ts₃, . . . ts_{M}}, wherein each of the times {ts₀, ts₁, ts₂, ts₃, . . . ts_{M}} corresponds to one of {ysR,

$$( ysR + {N}_{1} \frac{λ}{2} ) , ( ysR + {N}_{2} \frac{λ}{2} ) , ( ysR + {N}_{3} \frac{λ}{2} ) , … ( ysR + {N}_{M} \frac{λ}{2} ) \} .$$

According to at least some example embodiments, the reference point may be arbitrarily selected by a user.

At S204, the control system 114 calculates the average velocity v̅ₘ of the object 100 during the time period tₘ−tₘ₊₁ using the equation

$${\overline{υ}}_{m} = \frac{{ys}_{m + 1} - {ys}_{m}}{{t}_{m + 1} - {t}_{m}} ,$$

which in the above example simplifies to

$${\overline{υ}}_{m} = \frac{( {N}_{m + 1} - {N}_{m} ) * 316}{{t}_{m + 1} - {t}_{m}} .$$

In at least some example embodiments, the velocity v̅ₘ of the object 100 may be constant.

At S206, the control system 114 predicts or extrapolates subsequent positions of the object 100 based on the subset S of the raw position data using the calculated velocity v̅ₘ of the object. In one example, the control system 114 may predict the position change Δy using equation (1):

Δy=(yₙ−yₒ)= v̅ₘ*Δt= v̅ₘ(tₙ−t₀) (1)

The above discussed example assumes the velocity of the object 100 is constant. However, example embodiments may also be implemented and utilized in situations where the velocity of the object 100 is not constant (the acceleration is non-zero). In these example embodiments, equation (1) may be replaced with equation (2):

$$\begin{matrix}Δ y = ( {y}_{n} - {y}_{0} ) \\ = {\sum }_{i = 1}^{n} {\overline{υ}}_{i} \cdot Δ {t}_{i} \\ = {\sum }_{i = 1}^{n} {\overline{υ}}_{i} \cdot ( {t}_{i} - {t}_{i - 1} ) .\end{matrix} \qquad ( 2 )$$

In an alternative example embodiment, S204 in FIG. 3 may be omitted and the position data may be extrapolated without calculating velocity.

In this example embodiment, the control system 114 predicts or extrapolates subsequent positions of the object 100 based on the subset S of the raw position data and corresponding time of the object 100 at each position ysᵢ. In one example, the control system 114 may predict the position y(t) of the object 100 at any time using a k order polynomial equation (3):

y(t)=(a₀+a₁t+a₂t²+a₃t³+ . . . +aₖt^{k}) (3)

In equation (3), k is an integer, aᵢ represents a constant to be determined using a best fit/match of the discrete data in the subset S. Because methods for determining best fit/matches, and consequently constants such as aᵢ, are well-known, a detailed description will be omitted.

As discussed above, the laser head 10X, the polarizing beam splitter 11X, the moving mirror 12X, the fixed mirror 13X, the quarter-wave plates 14X and 15X and the receiver 16X of the x-interferometer function in the same or substantially the same manner as the corresponding components in the y-direction, and thus, a detailed description will be omitted for the sake of brevity.

According to example embodiments, because the error repeats once for every λ/2, the position data separated by exactly λ/2 may be more trustworthy. Using this assumption, a relative position measurement may be realized, but an absolute error may remain. This absolute error, however, may be disregarded if a data point from the λ/2 subset is used as a reference point. All position data from this subset will have the same or substantially the same absolute error, and thus, all relative measurements within this subset have relatively little or no errors.

Said another way, because the error of the position data measured by an interferometer repeats periodically, varying from a lower boundary to a higher boundary with half of the laser wavelength (λ/2) along the position of the measured object, the measured datum of a particular point has the same or substantially the same error as a second datum of second point one period away (e.g., half of the laser wavelength away) from the first point. This second datum further has the same or substantially the same error to that of a third datum of a third position one further period away (e.g., another half of the laser wavelength away) from the second position.

More generally, an error E at any arbitrarily selected reference position ysR has the same or substantially the same value as the error at any other positions located integer numbers of the period (e.g., half of the laser wavelength) away from the reference position

$$( e . g . , ysR + N \frac{λ}{2} ,$$

where N is an integer).

According to example embodiments, if a subset of the raw position data is selected such that the distance between any two points of the sub-set position data are an integer number of the period apart, the errors of all points in the sub-set will have the same or substantially the same error value, instead of periodically repeated values. By selecting appropriate reference position of the data, the error of the sub-set data may be reduced and/or minimized.

The present invention being thus described, it will be obvious that the same may be varied in many ways. Such variations are not to be regarded as a departure from the present invention, and all such modifications are intended to be included within the scope of the present invention.

I claim:

1. An interferometer system for tracking a position of a movable object in a tool including a coordinate stage, the interferometer system comprising:
an interferometer configured to generate an interference signal indicative of at least one instantaneous position of an object; and
a control system configured to,
generate raw position data based on the generated interference signal, the raw position data representing a first and second position of the object, and
extrapolate at least a third position of the object based on the raw position data.

2. The interferometer system of claim 1, wherein the control system is further configured to,
select a subset of position data from the raw position data, the subset of position data including at least two data points, and wherein
the control system extrapolates at least the third position of the object based on the selected subset of position data.

3. The interferometer system of claim 2, wherein the at least two data points are at least a distance of λ/2 from one another, where λ represents a wavelength of a laser used to generate the interference signal.

4. The interferometer of claim 2, wherein the subset of position data is selected such that each data point in the subset has a same associated error.

5. The interferometer system of claim 2, wherein to generate at least the third position, the control system is further configured to,
calculate a velocity of the object based on the selected subset of position data, and wherein
at least the third position is extrapolated based on the at least two positions in the subset and the calculated velocity.

6. The interferometer system of claim 1, wherein the tool is one of a pattern generator, a metrology tool, and an inspection tool.

7. A tool including a coordinate stage, the tool comprising:
the interferometer system of claim 1, the object being the stage on which a workpiece is arranged; and
an exposure system for exposing the workpiece according to the tracked position of the object.

8. The tool of claim 7, wherein the tool is one of a pattern generator, a metrology tool, and an inspection tool.

9. A method for tracking a position of a movable object in a tool having a coordinate stage, the method comprising:
generating an interference signal indicative of at least one instantaneous position of an object;
generating raw position data based on the generated interference signal, the raw position data representing a first and second position of the object; and
extrapolating at least a third position of the object based on the raw position data.

10. The method of claim 9, further including,
selecting a subset of position data from the raw position data, the subset of position data including at least two data points, and wherein
the extrapolating extrapolates at least the third position of the object based on the selected subset of position data.

11. The method of claim 10, wherein the at least two data points are at least a distance of λ/2 from one another, where λ represents a wavelength of a laser used to generate the interference signal.

12. The method of claim 10, wherein the subset of position data is selected such that each data point in the subset has a same associated error.

13. The method of claim 10, wherein the generating of at least the third position further includes,
calculating a velocity of the object based on the selected subset of position data, and wherein
at least the third position is extrapolated based on the at least two positions in the subset and the calculated velocity.

14. The method of claim 9, wherein the tool is one of a pattern generator, a metrology tool, and an inspection tool.

15. A method for exposing a workpiece, the method comprising:
tracking a position of an object according to the method of claim 9, the object being the coordinate stage on which the workpiece is arranged; and
exposing the workpiece according to the tracked position of the object.
